(19) United States
(12) Patent Application Publication
(10) Pub. No.: US 2011/0175266 A1
(43) Pub. Date: Jul. 21, 2011

(54) VIBRATION ISOLATOR WITH ELECTROMAGNETIC CONTROL SYSTEM

(76) Inventor: James A. Baron, Hilliard, OH (US)

(21) Appl. No.: 13/010,313

(22) Filed: Jan. 20, 2011

Related U.S. Application Data
(60) Provisional application No. 61/296,723, filed on Jan. 20, 2010.

(51) Int. Cl. F16F 7/00

(52) U.S. Cl. 267/136

(57) ABSTRACT

A vibration isolation system includes first and second spaced apart supports. An elastic member is supported by the first and second supports and capable of bending in response to a load applied to a midportion of the elastic member intermediate the first and second supports to allow oscillation of the elastic member in response to a vibrating load in communication with the elastic member. An electromagnetic solenoid located below the elastic member and operably connected to the midportion of the elastic member to selectively apply load to the flexible member in a downward direction to adjust a natural frequency of the vibration isolation system. The electromagnetic solenoid can be adapted to alternatively or additionally selectively lock the elastic member against oscillation.

### CROSS-REFERENCE TO RELATED APPLICATIONS

The application claims the priority benefit of Provisional Patent Application No. 61/296,723 filed on Jan. 20, 2010, the disclosure of which is expressly incorporated herein in its entirety by reference.

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to vibration isolation systems and, more particularly, to vibration isolation systems with adjustable response while loaded and operating.

### BACKGROUND OF THE INVENTION

There are many means for isolating objects from shocks and vibration. One unique means of isolating objects from shocks and vibration has a flexible member supported on knife edge supports. See, for example, U.S. Pat. Nos. 6,220,563 and 6,595,483, the disclosures of which are expressly incorporated herein in their entireties by reference. These vibration isolation systems can be broadly applied across a wide spectrum of applications such as, for example, motors, marine engines, heating, ventilating and air conditioning equipment such as compressors, house hold appliances such as clothes washing machines, and architectural applications such as buildings and bridges. The hallmark feature of these vibration isolation systems is that they can be adjusted for natural frequency while loaded and operating, allowing the user excellent control over the systems. Furthermore, these vibration isolation systems exhibit non-linear trans-resonance behavior.

These vibration isolation systems typically include a knife-edge supported isolator (KESI), which comprise a flexible member supported on its ends by appropriate supports, with the load of the vibration source applied near the center of the flexible member. Natural frequency adjustment can be achieved by varying the distance between the end supports of the flexible member, symmetric about the load. The adjustment of the end supports can take place through a variety of mechanical means. See, for example, U.S. Pat. No. 7,086,509, the disclosure of which are expressly incorporated herein in its entirety by reference.

The mechanical means used to adjust the natural frequency of these systems suffer from some drawbacks, namely that adjustment is relatively slow. Also, these mechanical mechanisms can be expensive to implement and maintain. Accordingly, there is a need in the art for an improved means of controlling the natural frequency of vibration isolation systems that allow for rapid changes of natural frequency.

### SUMMARY OF THE INVENTION

Disclosed are vibration isolation apparatuses that overcome at least one of the disadvantages of the prior art described above. Disclosed is a vibration isolation system comprising, in combination, a first support, a second support spaced a distance from the first support, an elastic member supported by the first and second supports and capable of bending in response to a load applied to a midportion of the elastic member intermediate the first and second supports to allow oscillation of the elastic member in response to a vibrating load in communication with the elastic member, and an electromagnetic solenoid operably connected to the flexible member to selectively apply load to the flexible member to adjust a natural frequency of the vibration isolation system.

Also disclosed is a vibration isolation system comprising, in combination, a first support, a second support spaced a distance from the first support, an elastic member supported by the first and second supports and capable of bending in response to a load applied to a midportion of the elastic member intermediate the first and second supports to allow oscillation of the elastic member in response to a vibrating load in communication with the elastic member, and an electromagnetic solenoid operably connected to the elastic member to selectively lock the elastic member against oscillation.

Also disclosed is a vibration isolation system comprising, in combination, a first support, a second support spaced a distance from the first support, an elastic member supported by the first and second supports and capable of bending in response to a load applied to a midportion of the elastic member intermediate the first and second supports to allow oscillation of the elastic member in response to a vibrating load in communication with the elastic member, and an electromagnetic solenoid operably connected to the elastic member to selectively lock the elastic member against oscillation.

From the foregoing disclosure and the following more detailed description of various preferred embodiments it will be apparent to those skilled in the art that the present invention provides a significant advance in the technology and art of vibration isolation systems. Particularly significant in this regard is the potential the invention affords for a device that allows for rapid changes of natural frequency and is relatively inexpensive to produce and maintain. Additional features and advantages of various preferred embodiments will be better understood in view of the detailed description provided below.

### BRIEF DESCRIPTION OF THE DRAWINGS

These and further features of the present invention will be apparent with reference to the following description and drawing, wherein:

FIG. 1 is a schematic side elevational view of a vibration isolation system according to the present invention;

FIG. 2 is a schematic end elevational view of the vibration isolation system of FIG. 1;

FIG. 3 is an exploded side elevational view of a bearing structure of the vibration isolation system of FIG. 1;

FIG. 4 is a block diagram of an exemplary control system for the vibration isolation system of FIG. 1;

FIG. 5 is a schematic view of the vibration isolation system of FIG. 1, wherein a natural frequency control system is at rest or unenergized;

FIG. 6 is schematic view similar to FIG. 5 but wherein the natural frequency control system is energized;

FIG. 7 is a schematic view of a vibration isolation system according to another embodiment of the present invention, wherein a lock down system is at rest or unenergized; and

FIG. 8 is schematic view similar to FIG. 7 but wherein the lock down system is energized.

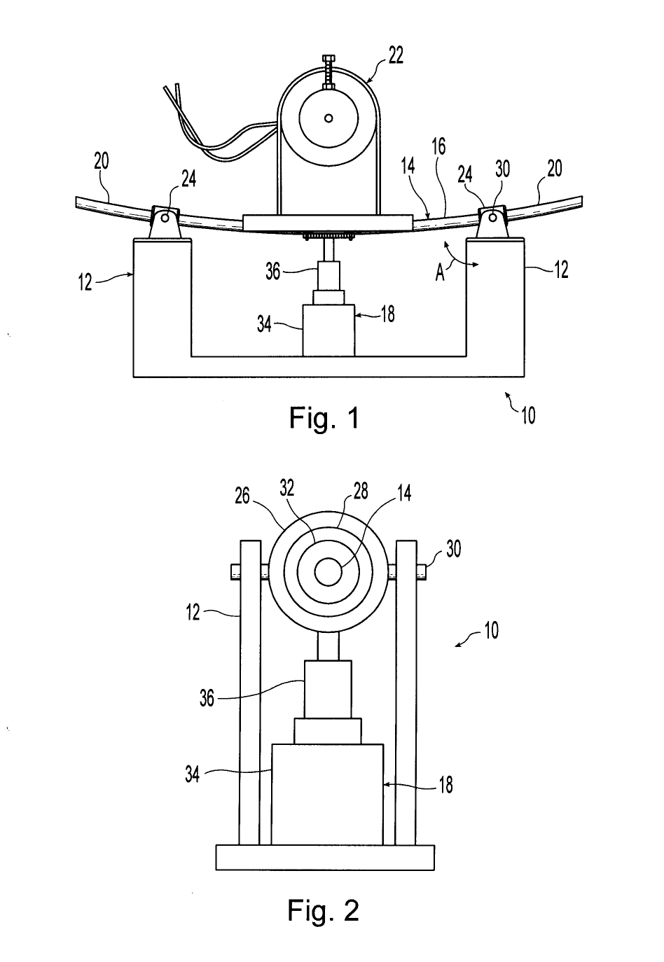

It should be understood that the appended drawings are not necessarily to scale, presenting a somewhat simplified representation of various preferred features illustrative of the basic principles of the invention. The specific design features of the vibration isolation systems as disclosed herein, including, for example, specific dimensions and shapes of the various components will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the vibration isolation systems illustrated in the drawings. In general, up or upward refers to an upward direction within the plane of the paper in FIG. 1 and down or downward refers to a downward direction within the plane of the paper in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved vibration isolation systems disclosed herein. The following detailed discussion of various alternative and preferred embodiments will illustrate the general principles of the invention. Other embodiments suitable for other applications will be apparent to those skilled in the art given the benefit of this disclosure.

FIGS. 1 to 3 illustrate a vibration isolation system 10 according to the present invention. The illustrated vibration isolation system 10 includes a first and second spaced-apart bearing supports 12, an elongate, flexible elastic member 14 supported by the first and second bearing supports 12 and capable of bending in response to a load applied to a midportion 16 of the elastic member 14 intermediate the first and second bearing supports 12 to allow oscillation of the elastic member 14 in response to a vibrating load in communication with the elastic member 14, and an electromagnetic solenoid 18 operably connected to the elastic member 14 to selectively apply load to the elastic member 14 to adjust a natural frequency of the vibration isolation system 10.

The illustrated elastic member 14 is supported solely by the bearing supports 12. The elastic member 14 is capable of deflecting from an original position to a more or less bowed position in response to changes in load in communication with the midportion 16 of the elastic member 14 intermediate its ends 20, with the amount of the deflection being dependent on the magnitude of the applied force within the load bearing capacity of the elastic member 14. The elastic member 14 is also capable of returning to its original position when the original force acting on the elastic member 14 is restored.

The elastic member 14 may comprise any suitable material including, but not limited to, metal, elastomer, composite materials, and the like which allow it to deflect in response to changes in the applied load and return essentially to its original position when the original load is restored. When the applied load is exerted primarily back and forth within a single plane, the elastic member 14 need not be capable of bending in a multitude of different directions so long as it is capable of bending in the direction(s) responsive to the applied force. The elastic member 14 should be selected to have a static deflection appropriate for the anticipated load, with greater static deflection being required to isolate lower frequency vibrations. The vibration isolation system 10 of the present invention is capable of effective isolation of frequencies as low as 1 Hz or less if an elastic member 14 having a suitably large static deflection is used.

The elastic member 14 can be a unitary member of continuous construction and can be of solid or hollow cross-section of any suitable shape or dimensions, including but not limited to solid rods, hollow tubes, or I-beams. The elastic member 14 may also be a composite member comprising a bundle of continuous elastic subunits held together by any suitable means. The elastic member 14 may also be a combination member having a central platform to accommodate the load. The platform can be integral with the elongate member or a separate element attached to the elongate member. The elasticity of the platform may be different from that of the platform as long as the elastic member has the characteristics described herein. Bores may be provided in the platform for mounting the vibration source 22 thereto.

The illustrated bearing supports 12 engage the elastic member 14 at a distance spaced from longitudinal, unrestrained ends 20 of the elastic member 14. Each of the illustrated bearing supports 12 are provided with a bearing structure 24 adapted to accommodate the shape and dimensions of the elastic member 14 and reduce friction between the bearing structure 24 and the elastic member 14. The bearing structure 24 may be a discrete element connected to the bearing support 12. The illustrated bearing structure 24 is secured to the bearing support 12 with mechanical fasteners but any other suitable connection can alternatively be utilized such as, for example, the bearing structure 24 can snapped into a recess of the bearing support 12, that is, secured with a snap-in connection. Alternatively, the bearing structure 24 can be formed integrally with the bearing support 12.

The illustrated bearing structure 24 includes a bearing mount 26 which is pivotably mounted to the bearing support 12 with a pivot pin 30. The bearing mount 26 supports a bearing surface 32 that engages the elastic member 14. The bearing surface 32 may take the form of an elongated bearing sleeve, an open channel, a knife edge, and the like. A shock-absorbing spacer 28 can be located between the bearing surface 32 and the bearing mount 26 if desired. The bearing surface 32 receives the end portion 20 of the elastic member 14. The bearing structure 24 pivots relative to the bearing support 12 in response to the bending of the elastic member 14. Protective boots or shields can be utilized to prevent entry of dust or debris which may increase friction between the bearing sleeves and the elastic member. It is noted that the bearing structure 24 can alternatively be of any other suitable design and composition.

To minimize friction between the elastic member 14 and the bearing surfaces 32, a friction resistant interface can be provided between the exterior engagement surface of the end portions 20 of the elastic member 14 and the interior engagement surface of the bearing structure 24. This may be accomplished by providing selective materials and finishes such as, for example, fluoropolymers, highly polished materials, and the like for the engagement surfaces so that the elements slide easily relative to one another. Alternatively or in addition to the above, lubricants, a stream of air or other gas, and the like can be interposed between the engagement surfaces to reduce friction therebetween. If suitable friction-resistant materials and/or lubricants are used, satisfactory vibration isolation can be achieved using a bearing structure 24 that is fixedly connected to the bearing support 12 to prevent relative movement therebetween. Thus, the elastic member 14 slides relative to the fixed bearing structure 24, but the bearing structure 24e does not pivot relative to the bearing support 12.

The illustrated electromagnetic solenoid 18 includes a wound coil 34 and a soft iron armature or core 36 which longitudinally moves within a central passage or opening of the coil 24. An end of the armature 36 is operably attached to the central or midportion 16 of the elastic member 14 so that it can selectively apply loads thereto as described in more detail hereinafter. The armature 36 can be attached to the elastic member 14 in any suitable manner. The coil 34 is located about the armature 36 so that when electrical current is passed through the coil 34, a magnetic field is generated and the soft iron armature 36 is drawn into the coil 34. It is noted that in other embodiments it may be desirable so that the armature 36 is pushed out of the coil when electrical current is passed through the coil 34 depending whether the electromagnetic coil 34 needs to apply a pulling or pushing load to the elastic member 14. The force with which the iron armature 36 is drawn into the coil 34 varies proportionally to the magnitude of the current flowing through the coil 34, so the force imparted upon the elastic member 14 by the electromagnetic solenoid 18 can be varied as desired.

The illustrated electromagnetic solenoid 18 is position so that it applies a load to the elastic member 14 in the vertical direction but it is noted that the solenoid 18 can be positioned to provide a load in any other suitable direction depending on the requirements of the application. The illustrated coil 34 is fixedly secured below the midportion 16 of the elastic member 14 and the armature 36 extends upwardly from the coil 34 to the elastic member 14. When electric current is applied to the coil 34 the armature 36 is drawn into the coil 34 and downwardly pulls the midportion 16 of the elastic member 14 to apply additional load to the elastic member 14.

In a single spring/mass system, the natural frequency fn is related to the spring constant and the mass involved in the system per:

$$fn = \frac{1}{2 π} \sqrt{\frac{k}{m}}$$

where k is the spring constant and m is the mass. As the mass of the system varies with a constant spring constant, the natural frequency of the system varies inversely with the square root of the mass. Thus, when current is applied to the solenoid 18 in the vibration isolation system 10 described above, the apparent mass of the system 10 is increased, thus lowering the natural frequency. As the current is varied through the coil 34, the natural frequency of the system 10 is varied within a range proportional to the magnitude of the current. This allows a means of adjusting the natural frequency of the system 10 that allows for rapid changes of natural frequency.

FIG. 4 illustrates an exemplary control system 38 which includes a controller 40 which operates the electromagnetic solenoid 18 of the vibration isolation system 10 as well as a motor 42 or other component of the vibration source 22. The illustrated controller 40 is also in communication with a power source 44. The magnitude of the current applied to the electromagnetic solenoid 18 is varied by the controller 40 depending on the operation of the vibration source 22 and thus the desired natural frequency of the vibration isolation system 10. For example, if the vibration source 22 is front-loading clothes washing machine or a portion thereof, the natural frequency of the vibration isolation system 10 can automatically be adjusted depending on the wash cycle and/or speed of rotation of the drum to provide optimized vibration isolation. Alternatively and/or additionally, the controller 40 can be in communication with a vibration sensor 46 which provides signals relating to current vibrations produced by the vibration source 22 so that the controller 40 can rapidly and in real time adjust the natural frequency of the vibration isolation system 10 depending the current vibration conditions of the vibration source 22.

Inherent in the illustrated vibration isolation system 10 is its non-linear relationship between resonant frequency and flexible member displacement, where the further the flexible member 14 is displaced, the ‘softer’ the system 10 becomes up to a certain point where the system 10 becomes unstable. Thus, larger changes to natural frequency can be observed than would be for a simple single mass/single spring system.

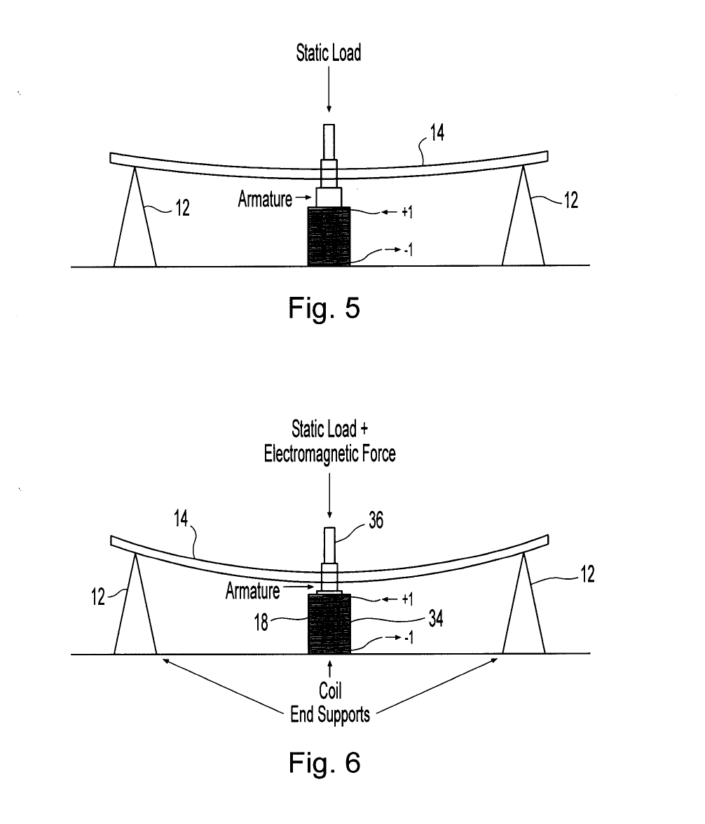

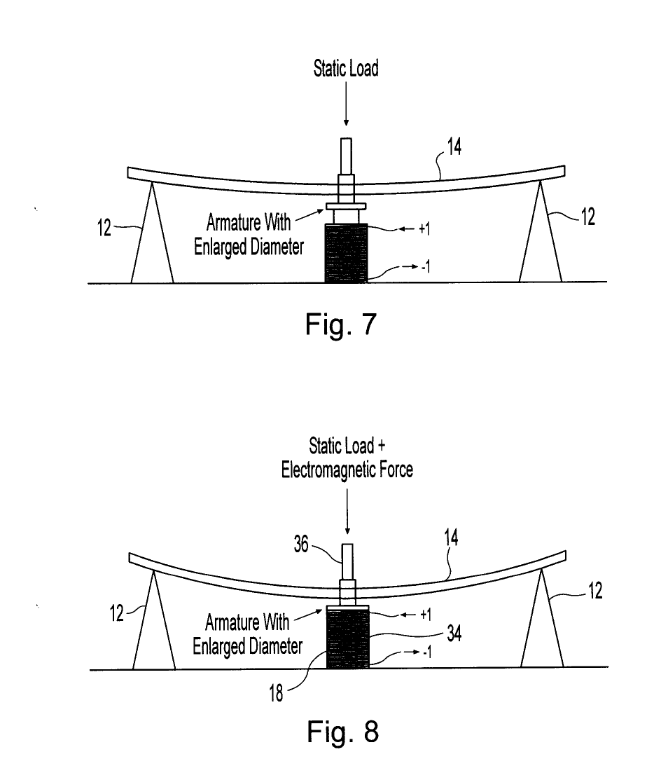

As shown in FIGS. 1 and 5, the vibration source 22 is placed in communication with the mid portion 16 of the elastic member 14. The elastic member 14 bends in response to the vibration transmitted to it by the vibration source 22. Variations in the load applied to the elastic member 14 cause the elastic member 14 to bear on its bearing supports 12 at different positions along the ends of the elastic member 14. As the load on the elastic member 14 exerts a downward force and the elastic member 14 bows downwardly in response to this load, the length of the midportion 16 of the elastic member 14 extending between the bearing supports 12 increases beyond any beyond any dimension caused solely by thermal expansion and contraction. The length of the midportion 16 correspondingly decreases when the downwardly directed force associated with the load. As shown in FIG. 6, when the electromagnetic solenoid 18 is energized, an additional force is applied to the elastic member 14 by the pulling armature 36 so that the elastic member 14 further bows downwardly.

Effective vibration isolation can be achieved with a system 10 having a single elastic member 14 in communication with the vibration source 22. However, the vibration source 22 can alternatively be in communication with a plurality of spaced apart elastic members 14, each supported on bearing supports 12 as described hereinabove.

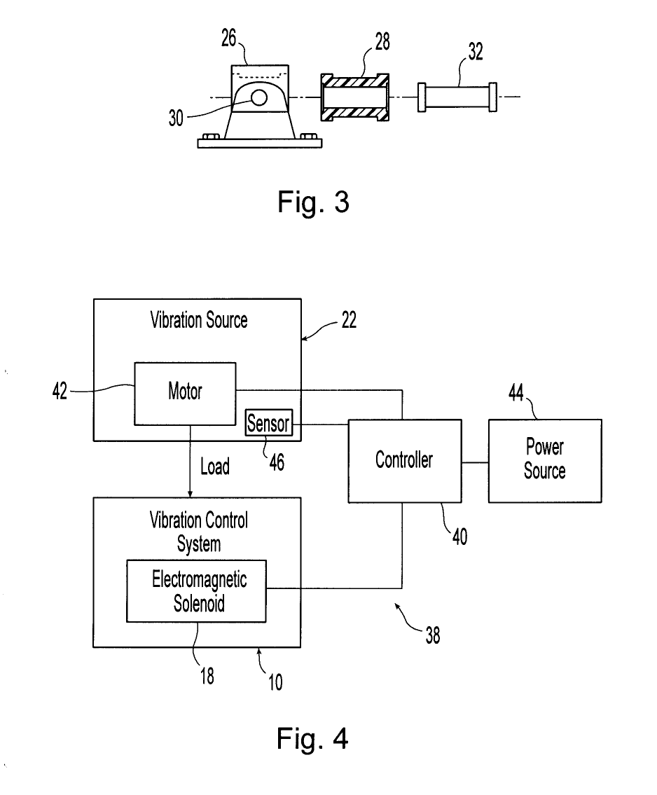

FIGS. 3 and 4 show a vibration isolation system 100 according to a second embodiment of the present invention where like reference numbers are utilized to indicate like structure. The second embodiment is substantially the same as the first embodiment described hereinabove except that the electromagnetic solenoid 18 of the frequency adjustment system is adapted to alternatively or additionally operate as a lock down system. The lock down system is used in applications where there is a need to secure the vibration isolation system 100 against movement. The illustrated lock down system includes a downward facing abutment 102 that engages an upward facing abutment 104 located in a fixed position when sufficient current is supplied to the coil 34 (best seen in FIG. 8). With the core abutment 102 pulled against the fixed position abutment 104, the core 36 is locked thereto to prevent relative movement therebetween as long as the current is maintained. As a result, the elongate member 14 is also locked in its position as long as the current is maintained. The illustrated downward-facing abutment 102 is formed by a flange on the core 36 which has a diameter larger than the opening in the coil 34 so that it engages the upwardly facing abutment 104 formed at the top of the coil 34 when the core 36 is pulled completely into the coil 34. It is noted that the abutments 102, 104 can alternatively be formed in any other suitable manner.

Any of the features or attributes of the above the above described embodiments and variations can be used in combination with any of the other features and attributes of the above described embodiments and variations as desired.

From the foregoing disclosure it will be apparent that the present invention provides an improved means for rapidly changing natural frequency of the system and/or locking the system.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A vibration isolation system comprising, in combination:
a first support;
a second support spaced a distance from the first support;
an elastic member supported by the first and second supports and capable of bending in response to a load applied to a midportion of the elastic member intermediate the first and second supports to allow oscillation of the elastic member in response to a vibrating load in communication with the elastic member; and
an electromagnetic solenoid operably connected to the elastic member to selectively apply load to the elastic member to adjust a natural frequency of the vibration isolation system.

2. The vibration isolation system according to claim 1, wherein the electromagnetic solenoid is operably connected to the midportion of the elastic member.

3. The vibration isolation system according to claim 1, wherein the electromagnetic solenoid has a core moveable within a coil and the core is connected to the elastic member.

4. The vibration isolation system according to claim 3, wherein the core connected to the midportion of the elastic member.

5. The vibration isolation system according to claim 3, wherein the core moves in a vertical direction to apply load to the elastic member.

6. The vibration isolation system according to claim 5, wherein the core moves in an downward direction to apply load to the elastic member.

7. The vibration isolation system according to claim 1, wherein the electromagnetic solenoid moves in a vertical direction to apply load to the elastic member.

8. The vibration isolation system according to claim 7, wherein the electromagnetic solenoid moves in an downward direction to apply load to the elastic member.

9. The vibration isolation system according to claim 1, further comprising a controller operatively in communication with the electromagnetic solenoid to supply current to the electromagnetic solenoid based on operating conditions of a vibration source supplying load to the elastic member.

10. A vibration isolation system comprising, in combination:
a first support;
a second support spaced a distance from the first support;
an elastic member supported by the first and second supports and capable of bending in response to a load applied to a midportion of the elastic member intermediate the first and second supports to allow oscillation of the elastic member in response to a vibrating load in communication with the elastic member; and
an electromagnetic solenoid located below the elastic member and operably connected to the midportion of the flexible member to selectively apply load to the elastic member in a downward direction to adjust a natural frequency of the vibration isolation system.

11. A vibration isolation system comprising, in combination:
a first support;
a second support spaced a distance from the first support;
an elastic member supported by the first and second supports and capable of bending in response to a load applied to a midportion of the elastic member intermediate the first and second supports to allow oscillation of the elastic member in response to a vibrating load in communication with the elastic member; and
an electromagnetic solenoid operably connected to the elastic member to selectively lock the elastic member against oscillation.

12. The vibration isolation system according to claim 11, wherein the electromagnetic solenoid is operably connected to the midportion of the elastic member.

13. The vibration isolation system according to claim 11, wherein the electromagnetic solenoid has a core moveable within a coil and the core is connected to the elastic member.

14. The vibration isolation system according to claim 13, wherein the core connected to the midportion of the elastic member.

15. The vibration isolation system according to claim 13, wherein the core moves in a vertical direction to apply load to the flexible member.

16. The vibration isolation system according to claim 15, wherein the core moves in an downward direction to apply load to the elastic member.

17. The vibration isolation system according to claim 13, wherein the core has an abutment which engages a fixed position abutment when the coil is suitably energized to lock the system.

18. The vibration isolation system according to claim 13, wherein the abutment of the core is formed by a flange and the fixed position abutment is formed on the coil.

19. The vibration isolation system according to claim 11, wherein the electromagnetic solenoid moves in a vertical direction to apply load to the elastic member.

20. The vibration isolation system according to claim 17, wherein the electromagnetic solenoid moves in an downward direction to apply load to the elastic member.
